(19) United States
(12) Patent Application Publication
(10) Pub. No.: US 2013/0005273 A1
(43) Pub. Date: Jan. 3, 2013

(54) Method and System for Accessing a Telecommunications Network

(75) Inventors: Annemieke Kips, Leiden (NL); Antonius Norp, The Hague (NL); Michael Schenk, The Hague (NL); Johannes Maria van Loon, Zoetermeer (NL)

(73) Assignees: Koninklijke KPN N.V., The Hague (NL); Onderzoek TNO, Delft (NL); Nederlandse Organisatie Voor Toegepast-Natuurwetenschappelijk

(21) Appl. No.: 13/577,640

(22) PCT Filed: Feb. 3, 2011
(86) PCT No.: PCT/EP11/51590

§ 371 Date: Sep. 12, 2012

(30) Foreign Application Priority Data
Feb. 8, 2010 (EP) 10152883.4

(51) Int. Cl. H04W 4/00; H04B 17/00; H04B 7/24

(52) U.S. Cl. 455/67.11; 455/39

(57) ABSTRACT

The invention relates to a method and network for receiving at least a first access request from a first device and a second access request from a second device. A first message is transmitted from the network to the first device, wherein the first message comprises a first access time or first access time window. Similarly, a second message is transmitted from the network to the second device, wherein the second message comprises a second access time or second access time window. The first access time or first access time window is different from the second access time or second access time window. Subsequent to the first message, the network receives the first access request from the first communication device at or after the first access time or within the first access time window and, subsequent to the second message, the network receives the second access request at or after the second access time or within the second access time window from the second device.

### FIELD OF THE INVENTION

The invention relates to the field of telecommunications. More specifically, the invention relates to the field of controlling access of a number of communication devices in machine-to-machine (M2M) communications.

### BACKGROUND OF THE INVENTION

Telecommunications networks that provide wireless access (e.g. GSM, UMTS, WiMax, LTE) have developed tremendously over the past years. In such networks, voice and data services can be provided to communication devices having a high mobility, i.e. the communication devices are not bound to a particular location and are freely movable through the area covered by the network. A gateway node of the telecommunications network enables connection to a further network, for example a network based on IP such as the internet.

The availability of such a telecommunications network connected to the further network has resulted in demands for further services, including services that relate to so-called machine-to-machine (M2M) communications, also referred to as machine-type communications (MTC). M2M is currently being standardized in 3GPP (see e.g. TS 22.368). MTC applications typically involve hundreds, thousands or millions of communication devices which each act as a communication devices to the telecommunication network. Such communication devices may be stationary or non-stationary. An example involves the electronic reading of e.g. ‘smart’ electricity meters at the homes of a large customer base over the telecommunications network from a server connected to the further network. Other examples include sensors, meters, vending or coffee machines, car meters for route pricing applications, navigation equipment etc. that can be equipped with communication modules that allow exchanging information with other equipment, such as a data processing centre over the telecommunications network. Such devices may also be monitored by the data processing centre. The data processing centre may e.g. store the data and/or provide a schedule for maintenance people to repair or refill a machine, meter or sensor or may update information in the device. Also, the data processing centre may be configured for processing data received from mobile communications devices, e.g. for road pricing applications.

Generally, in cases of potentially many coincident requests from devices to a network, some form of control of the use of network resources is desired. As an example, many mobile devices are nowadays able to retrieve e-mail messages from a network. Lots of devices may be programmed to retrieve e-mail messages exactly at the same moment in time, many times a day.

More particularly for M2M applications, EP 2 096 884 discloses specifying one or more time intervals in the telecommunications network during which a particular communication device or group of communication devices is allowed to access the network in order to enable a network operator to control the use of network resources. Access requests to the network outside the specified time intervals are denied. In doing so, the network operator is enabled to plan the use of network resources more accurately.

Whereas this approach enables the network operator to provide certain access grant time intervals to specific groups of customer devices during which access to the network may be granted, the actual use by these customer devices during such time intervals is at the discretion of the customer or device and can not be controlled from the network.

Therefore, there exists a need in the art for improved control of network resources by a network operator.

### SUMMARY OF THE INVENTION

A method for receiving at least a first access request from a first device and a second access request from a second device at a telecommunications network is disclosed. A first message is transmitted from the network to the first device, wherein the first message comprises a first access time or first access time window. Similarly, a second message is transmitted from the network to the second device, wherein the second message comprises a second access time or second access time window. The first access time or first access time window is different from the second access time or second access time window. In other words, the first and second devices receive different access time indications.

Subsequent to the first message, the network receives the first access request from the first communication device at or after the first access time or within the first access time window and, subsequent to the second message, the network receives the second access request at or after the second access time or within the second access time window from the second device.

It should be appreciated that the indications first access request and second access request are used to link these requests to the first and second device, respectively. These indications are not meant to indicate a first or second request in time.

A computer program or set of computer programs for executing the method is also disclosed.

A telecommunications network arranged for receiving at least a first access request from a first device and a second access request from a second device is also disclosed. The telecommunications network comprises one or more network nodes. These one or more network nodes are arranged for generating and transmitting a first message comprising a first access time or first access time window to the first device and a second message comprising a second access time or second access time window to the second device and are further arranged for receiving the first access request from the first communication device at the first access time or within the first access time window and the second access request at the second access time or within the second access time window. The first access time or first access time window is different from the second access time or second access time window. It should be appreciated that various functions may be distributed over various nodes, wherein e.g. a first node generates the first access time (window) and a second node receives the first access request. The second node or a third node may verify whether the request is received at or after the first access time.

Furthermore, a network node is disclosed that is configured for generating and/or transmitting a first message comprising a first access time or first access time window to a first device and a second message comprising a second access time or second access time window to a second device, the first access time or first access time window being different from the second access time or second access time window. The network node is further configured for receiving the first access request from the first communication device at the first access time or within the first access time window and the second access request at the second access time or within the second access time window.

Moreover, a communications device is disclosed that is configured for transmitting access requests to a telecommunications network for data delivery or exchange. The device is configured for receiving a message from the telecommunications network, the message comprising an access time or access time window. The device comprises a controller configured for processing the received message and providing a control signal for transmitting an access request to the network at the access time or within the access time window. The device also comprises a transmitter configured for transmitting the access request at the access time or within the access time window in response to receiving the control signal. The communications device may comprise a storage for storing the access time or access time window from the message and the controller may be configured for transmitting a subsequent access request at the access time or within the access time window as defined in the storage.

The communications device may further comprise means for deriving a new access time for the received access times and store the derived access time or information enabling the device to calculate an access time or access time window. This embodiment enables the communications device to request access multiple times, e.g. periodically, to the network after receiving e.g. a single message from the network comprising the access time or access time window.

The first and second messages may be transmitted to the first and second device, respectively, during a previous message exchange with the network. The previous message exchange may or may not have resulted in an attach of the communication device to the network or a connection with the network.

By providing the devices with specific network-controlled access times or access time windows, the operator of the network is given improved control of the use of the network resources by these devices, thereby enabling a substantially decreased risk of overload on these resources by a peak of access requests and also to further optimization of the use of these resources. The communications devices receive from the network information about the starting time or time window when access is likely to be granted. This information may be provided e.g. in response to an access request (which may be denied or granted) or during a previous message exchange with the network, thereby relieving the customer from the burden to individually program devices with different access times or access time windows or to otherwise schedule suitable access times.

It should be appreciated that the access request may be a circuit-switched access request or a packet-switched access request. Steps of accessing a telecommunications network are generally standardized, e.g. in 3GPP TS 23.060, and may involve various phases. Access requests as defined herein involve any of these phases and can, in various networks known in the art, be distinguished as at least a network attach and a network connection.

In an embodiment of the invention, the first access time or time window and the second access time or time window are defined within an access time group interval applicable for a group of communications devices, the access time group interval being defined between an interval start time and an interval stop time. This embodiment advantageously enables controlling access times or time windows of one or more particular devices within an assigned group time interval, thereby improving control of network resources by the network operator also within such group time intervals. In an embodiment of the invention, the first access time or first time window and the second access time or second access time window are defined as time offsets from the interval start time or the interval stop time of the access time group interval. Accordingly access times or time windows are defined independently of the absolute time, thereby enabling adapting the access time group intervals to accommodate e.g. different time zones or for changes between daylight saving time and winter time.

Although the access times or time windows provided from the network may be determined according to any suitable algorithm, the first access time and the second access time may be generated by the network as random values. For access time windows the start times of these windows may be generated. This embodiment provides a relatively simple manner of obtaining different access times for the devices. As an example, different access times are obtained by randomly selecting access times from a set of access times which values are uniformly distributed over a predetermined range.

For a particular group of devices, a pattern of access requests may be monitored for a period. Analysing this pattern may reveal further optimization possibilities in the use of network resources. In an embodiment of the invention, if a change in the pattern is desired, the first access time or first access time window and second access time or second access time window may be selected or otherwise obtained such that the desired change in the time pattern is realized.

The network may enforce the access times or access time windows provided to the devices with the messages when devices try to request access to the network despite these instructed access times or windows. The first access request may be denied when the first access request is received prior to the first access time or outside the first access time window and the second access request may be denied when the second access request is received prior to the second access time or outside the second access time window. Denying an access request as used herein includes rejecting the request by returning a reject message to the device or blocking/ignoring the request without informing the device, the latter option being advantageous for not claiming further network resources. A condition for denying an access request may e.g. be the receiving of an access request prior to the access time or start of the access time interval. In order to penalize the devices disobeying to the access time indications and/or to enforce a minimum period between subsequent access requests, the first and second access times may be delayed to a time after the access times or access time windows previously provided to the devices. The devices may be informed of the further delay via further messages from the network. In order to save resources, however, the network may restart the timer for the device and the device may do the same at the device side, using a predetermined value for the further delay.

The access times or access time windows provide information to the devices regarding the allowable start time or time window for requesting access. However, e.g. when a particular access time group interval applies during which access by the device is allowed, the devices may stay attached to the network or even maintain a connection with the network during the remainder of the group time interval, as long as the access request is received at the access time or within the access time window. In an embodiment of the invention, the network maintains a time budget for a device, defining how long a device may stay attached and/or connected to the network within a particular period of time. Alternatively, or in addition, the network may maintain a request amount budget for a particular device, specifying the (maximum) number of access requests allowed for the device within a particular period of time. An access request may be denied when at least one of the time budget and the request amount budget is depleted for a given period and the device has not accessed the network. When the device is attached to the network and the time budget is depleted, the network initiates a network detach procedure. When the device is connected to the network and the time budget is depleted, the network releases the connection with the device. This embodiment enables the operator to further control use of network resources, e.g. by disabling a device to claim network resources for too long a time after the access time received from the network.

Hereinafter, embodiments of the invention will be described in further detail. It should be appreciated, however, that these embodiments may not be construed as limiting the scope of protection for the present invention.

### BRIEF DESCRIPTION OF THE DRAWINGS

In the drawings:

FIG. 1 is a schematic illustration of a telecommunications network connecting communication devices to an application server;

FIGS. 2A and 2B provide time diagrams illustrating a message exchange between a first communications device 3A and the network 1 and a second communications device 3B and the network 1 of FIG. 1;

FIGS. 3A and 3B are schematic illustrations of a communications device and one or more network nodes according to an embodiment of the present invention;

FIGS. 4A and 4B provide schematic illustrations of network node arrangements according to embodiments of the invention; and

FIGS. 5A and 5B depict time diagrams illustrating transferring access time or access time windows from the network to a communication device according to embodiments of the invention.

### DETAILED DESCRIPTION OF THE DRAWINGS

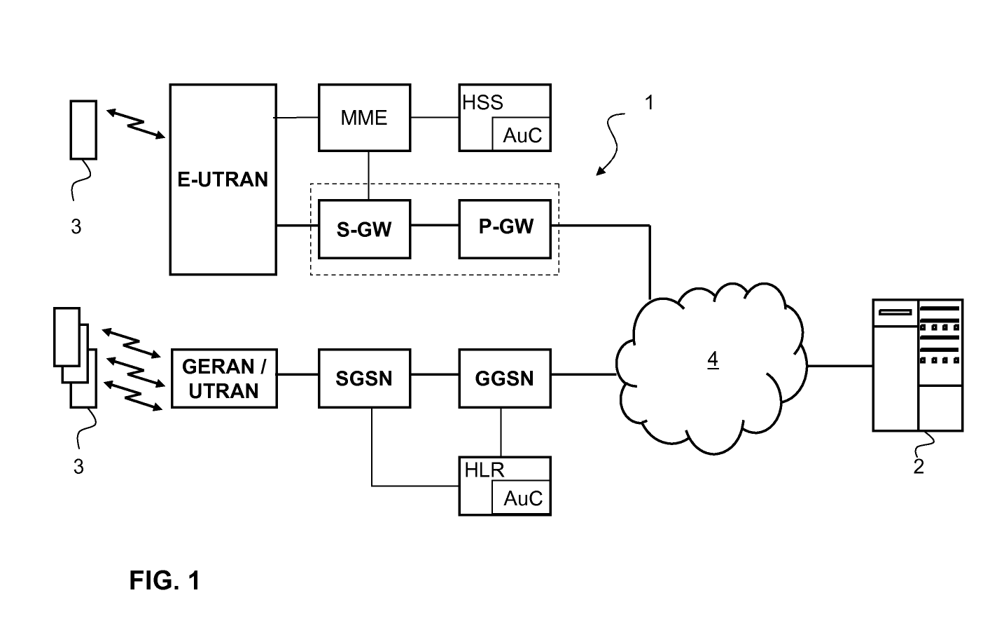

FIG. 1 shows a schematic illustration of a telecommunications network 1. The telecommunications network 1 enables data sessions between an application server 2 and a communication device 3 over a data network 4, wherein access of the communication device 3 to the telecommunications network 1 is wireless.

In the telecommunications network of FIG. 1, three generations of telecommunications networks are schematically depicted together for purposes of brevity. A more detailed description of the architecture and overview can be found in 3GPP TS 23.002 which is included in the present application by reference in its entirety.

The lower branch of FIG. 1 represents a GPRS or UMTS telecommunications network comprising a Gateway GPRS Support Node (GGSN), a Serving GPRS Support Node (SGSN) and a Radio Access Network (GERAN or UTRAN). For a GSM/EDGE radio access network (GERAN), the access network comprises a Base Station Controller (BSC) connected to a plurality of Base Station Transceivers (BTSs), both not shown. For a UMTS radio access network (UTRAN), the access network comprises a Radio Network Controller (RNC) connected to a plurality of NodeBs), also not shown. The GGSN and the SGSN are conventionally connected to a Home Location Register (HLR) that contains subscription information of the communication devices 3. In the figure, the HLR is combined with an authentication centre (AuC) for authenticating communication devices 3 in the network.

The upper branch in FIG. 1 represents a next generation telecommunications network, commonly indicated as Long Term Evolution (LTE) or Evolved Packet System (EPS). Such a network comprises a PDN Gateway (P-GW) and a Serving Gateway (S-GW). The E-UTRAN of the EPS comprises evolved NodeBs (eNodeBs or eNBs) providing wireless access for a communication device 3 that is connected to the S-GW via a packet network. The S-GW is connected to a Home Subscriber Server HSS and a Mobility Management Entity MME for signaling purposes. The HSS includes a subscription profile repository and an authentication centre (AuC).

Further information of the general architecture of a EPS network can be found in 3GPP TS 23.401.

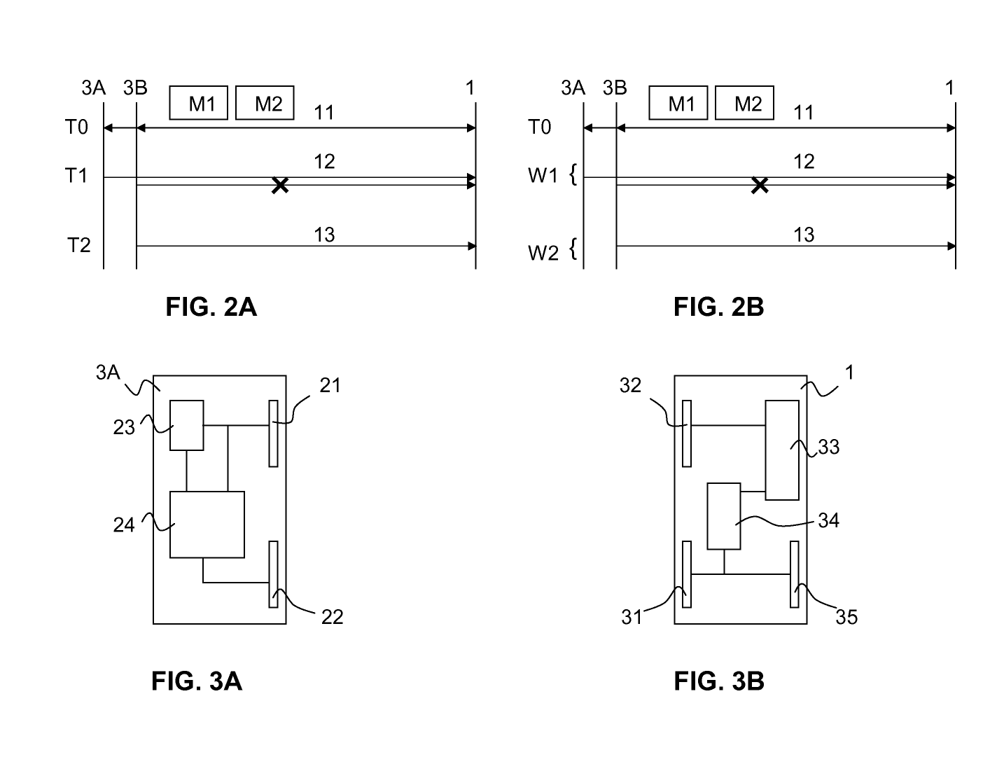

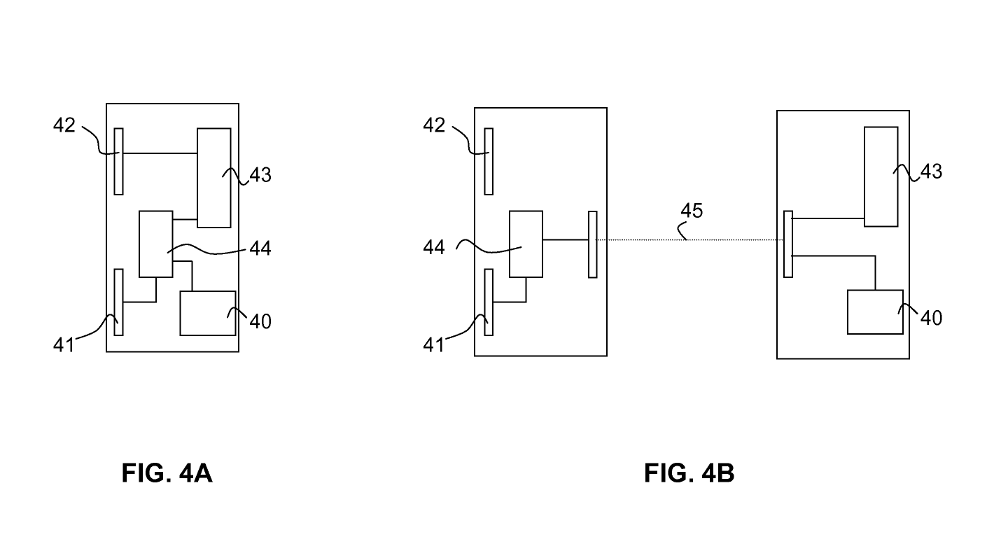

FIGS. 2A and 2B provide time diagrams illustrating a message exchange between a first communications device 3A and the network 1 and a second communications device 3B and the network 1 according to an embodiment of the invention. FIG. 3A is a schematic illustration of a communications device 3A. FIG. 3B is a schematic illustration of one or more nodes of the network 1. FIG. 3B shows operative means that may be distributed over various nodes of a network (e.g. a HLR/HSS, a SGSN/MME and/or a node of an access network, e.g. a NodeB/eNB) as will be explained in further detail with reference to FIGS. 4A and 4B).

In step 11 of FIG. 2A and FIG. 2B, both the first and second communications devices 3A, 3B interact with the network 1 at a time T0 using receiving means 21, 31 and transmitting means 22, 32 at the device side and the network side, respectively.

The message exchange may be due to a previous power outage wherein, after power is restored, the communications devices 3A, 3B try to attach or connect to the network 1 again. Another example includes coincident scheduled access requests from e.g. e-mail clients running on the devices 3A, 3B.

The interaction of the devices 3A, 3B with the network 1 may result in a reject message from the network 1, an attach to the network 1 without successfully establishing a connection or a connection with the network 1. In any case, during the interaction, according to an embodiment of the invention, the first communications device 3A receives a first message M1 with a first access time T1 or first access time window W1 and the second communications device 3B receives a second message M2 containing a second access time T2 or second access time window W2. Access times T1 and T2 are different. Access time windows W1 and W2 may partly overlap. To facilitate the communication device 3A, 3B, the message M1, M2 may also include time T0. Access times T1, T2 are generated in the network 1 using a predetermined algorithm using generator 33 for identified communication devices 3A, 3B. The same holds for the start time of the access times windows W1 and W2. The duration of the time windows may have a same value. The access times T1, T2 or access time windows W1, W2 are also provided to access grant module 34 within the network. Access grant module 34 may include a clock and therefore be able to determine whether times T1, T2 have passed or whether access time windows W1, W2 have started or expired. Access grant module 34 may alternatively or in addition include a timer, started e.g. at T0 and therefore be able to determine whether times T1, T2 or the start and stop times of windows W1, W2 have passed.

The communication devices 3A, 3B extract or derive the first and second access times T1, T2 or time windows W1, W2 from the first and second message M1, M2, respectively and store the access times T1, T2 or windows W1, W2 in a storage 23. A controller 24 of the communication devices 3A, 3B monitors time and, at times T1, respectively, T2 requests access to the network using transmitter 22. The access request may e.g. comprise a network attach request. In case of access times windows W1, W2, controller 24 ensures that access requests to the network are made within these windows.

In step 12 of FIG. 2A, receiver 31 of the network receives the access request comprising a subscription identifier or a device identifier and access grant module 34 of the network verifies whether the access request for this first communication module is received at time T1. If so, access is granted and further steps for performing the network attach (e.g. authentication or location management) or establishing the convection can be taken. As an example, a connection can be established with a further network node or server outside the network, using interface 35 of the network 1.

FIG. 2A also illustrates (by the cross) that the second communication device 3B is not granted access to the network 1 at access time T1. Access grant module 34 denies the access for this device until access time T2 is reached and an access request is received at that time (step 13). In doing so, an operator of the network 1 now is enabled to control access to the network 1 by the devices 3A, 3B.

Similarly, as shown in FIG. 2B, communication device 3A is granted access to the network 1 when the access request is made within access time window W1 (step 12) and communication device 3B is granted access to the network 1 when the access request is made within access time window W2 (step 13). The exact access time within a window W1, W2 may be chosen by the device 3A, 3B, e.g. randomly. FIG. 2B also illustrates (by the cross) that the second communication device 3B is not granted access when it requests access within access time window W1; this request is outside the second access time window W2.

In an embodiment of the invention, access grant module 34 may even deny the second device 3B access at time T2 until a time later than T2 (e.g. by restarting the timer for the second device 3B), thereby further postponing the access time or start of the access time window, when a communications device makes an attempt to access the network at a time other than the instructed access time or outside the instructed access window. Access grant module 34 may comprise monitoring means configured for monitoring the receiving of access requests from at least the first device 3A and the second device 3B. A time pattern of the access requests may be analysed and, if a change in the time pattern is desired, access grant module 34 may instruct generator 33 to generate access times T1, T2 or access time windows W1, W2 and provide these to the communication devices 3A, 3B to accomplish the desired change in the time pattern. As an example, access grant module may detect during message exchange 11 that access requests from devices 3A and 3B are timed simultaneously at time T0 and instruct these devices to request access at times T1, T2 in the future.

In the remainder of the present disclosure, an embodiment in the field of machine-to-machine (M2M) communications will be described in further detail, wherein use is made of access time windows W. It should be appreciated that, alternatively, such an embodiment is feasible using access times T.

In an M2M environment, a single server 2 normally is used for communication with a large number of communication devices 3. Individual communication devices 3 can be identified by individual identifiers, such as an IP address, an IMSI or another subscriber identifier. Communication devices 3 may either be (substantially) stationary devices or non-stationary devices. An example of stationary devices includes electricity meters. An example of non-stationary devices are car-mounted devices for road pricing applications.

FIGS. 4A and 4B provide schematic illustrations of nodes of a telecommunications network according to embodiments of the invention.

FIG. 4A depicts a network node e.g. a HLR/HSS or a SGSN/MME of the telecommunications network 1. The network node comprises a register 40 configured for storing an identifier of a communication device 3 or group of devices in combination with at least one access time group interval for a group of devices, or an equivalent thereof, during which access requests are permitted for the group of devices. The access time group interval is defined between a start time and a stop time. The access time group interval is typically agreed between the network operator and a customer operating the server 2 and the communications devices 3.

The network node comprises a receiving interface 41 and a transmitting interface 42 for communicating with a further network node or directly with the communication device 3.

In addition to the access time group interval, the network node may provide an access time window for a particular communication device or subset of communications devices of the group of communication devices. The access time windows W are typically determined or generated by the network operator without involvement of the customer. The network node may e.g. use an access time generator 43 that generates random (including pseudo-random) values as time offsets for the start time of the access time windows from the start time of the access time group interval for each individual communication device 3A, 3B, etc. As an example, the access time group interval for a group of terminals 3 may be between 1 am and 3 am. The time offset of device 3A may be 1 minute and the time offset for device 3B may be 23 minutes. When the duration of the access time windows is assumed to be 5 minutes, device 3A is able to successfully request access to the network 1 within time window W1=1:01-1:06 am and device 3B is able to successfully request access within W2=1:23-1:28 am. Alternative to specifying a start time offset in absolute units of time (minutes), the offset may be specified relatively, e.g. relative to the duration of the access time group interval. In the above example, the relative time offset could be 0.008333 (1/120) for device 3A and 0.191667 (23/120) for device 3B.

The network node comprises an access grant module 44 permitting access to devices 3A and 3B, provided that the requests for access to the network are not only within the access time group interval between 1 am and 3 am but also within W1 and W2, respectively (i.e. in accordance with the access time windows W1, W2 provided to the communication devices in an earlier stage).

As mentioned above, the network node of FIG. 4A may represent a HLR or HHS (e.g. in order to control whether or not to permit a network attach by terminals 3) or a SGSN or MME (e.g. in order to control whether or not to permit a network connection (e.g. establishing a PDP context) after a network attach has been successfully completed). In some cases, the anticipated number of access requests may be so large that over-loading of the HLR/HSS or SGSN/MME can be expected. In such cases it may be that at least the access time windows are retrieved or generated in the radio access network and the access grant module 44 is placed in the radio access network, e.g. in a base station, a NodeB or an eNodeB. Providing the access grant procedure in the radio access network is particularly feasible during the early stages of a network attach procedure wherein messages are not yet encrypted and the subscriber identity of the communications devices 3 and/or an indication of the communication device type can be determined in the radio access network.

FIG. 4B provides a further embodiment according to the invention, wherein the access grant functionality is distributed over two network nodes of the telecommunications network 1, e.g. a SGSN and a HLR or a MME and a HSS. Access time group intervals and access time windows are available, respectively, generated or provided in the HLR/HSS using register 40 and generator 43. This information is transferred to a lower network node SGSN/MME using communications interface 45. In the SGSN/MME, the access grant module 44 determines, based on the received access time group intervals and the access time windows whether or not to grant access (i.e. permit a network attach or a network connection, e.g. a PDP context). Alternatively, the arrangement of FIG. 4B depicts a SGSN and a lower network node in a radio access network.

It should be appreciated that further arrangements of network nodes have been envisaged, including a combination of three network nodes, e.g. a combination of a HLR-SGSN-NodeB or HSS-MME-eNodeB. The access time windows as described above provide information to the communications devices 3 regarding the allowable time window for requesting access within an access time group interval. However, e.g. when an access time group interval is applicable during which access by the devices 3 is allowed, the devices 3 may stay attached to the network 1 or even maintain a connection with the server 2 during the remainder of the access time group interval. In an embodiment of the invention, a network node (and particularly access grant module 44) maintains a time budget for a device 3, defining how long the device 3 may stay attached and/or connected within the access time group interval. Alternatively, or in addition, the network node may maintain a request amount budget for a particular device, specifying the (maximum) number of access requests allowed for the device 3. The time budget and the request amount budget may be defined and maintained in the HLR/HSS or in the SGSN/MME using timers and counters, respectively. The timers and counters may be reset after a particular period, thereby supplying to the time budget and request amount budget. Other mechanisms for budget- or credit keeping, which as such are known in the art, may also be used. When a communication device 3 is no longer attached to the network or connected to the server and the time budget is not yet depleted, the remaining time may be stored in the network node or a higher network node (e.g. the HLR/HSS) for later use, provided that the request amount budget is greater than 1. In case of non-stationary communications devices 3, the values of the timers and/or counters may need to be transferred between network nodes (e.g. between two SGSNs or between two MMEs). To facilitate the communication devices 3, the network may inform the device on the state of its budget(s), for example in a message M, or in an access grant/reject message or in a separate message.

An access request may be denied by the network node when at least one of the time budget and the request amount budget is depleted for a given period and the device has not accessed the network. When the device is attached to the network and the time budget and/or request amount budget is depleted, the network initiates a network detach procedure. When the device is connected to the network and the time budget and/or request amount budget is depleted, the network releases the connection with the device.

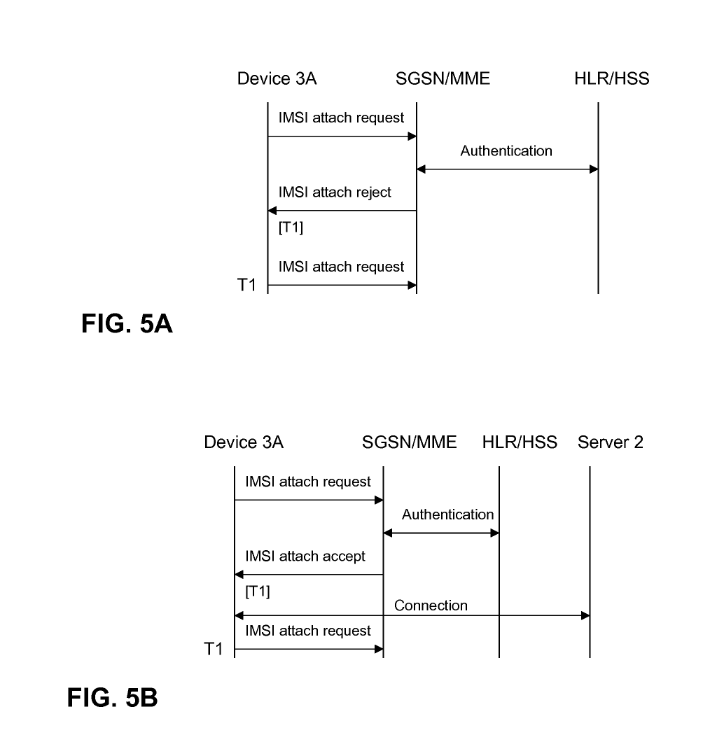

Finally, FIGS. 5A and 5B depict time diagrams illustrating various manners of transferring access time T1 from the network 1 to a communication device 3A. It should be appreciated that, instead of access time T1, an access time window W1 can be transferred to the communications device 3A in a similar manner.

In FIG. 5A, communication device 3A sends an IMSI attach request to an SGSN/MME via the radio access network (not shown). An authentication procedure is subsequently performed during which an authentication triplet or quintet is transferred from the HLR to the SGSN or from the HSS to the MME, respectively. During the authentication procedure, the HLR/HSS transfers the access time group interval and the access time T1 for communication device 3A to the SGSN/MME. Alternatively, the HLR/HSS transfers the access time group interval for communication device 3A to the SGSN/MME and the SGSN/MME determines the access time T1. The SGSN/MME may send an IMSI attach reject message to the communication device 3A. The IMSI attach reject message includes a message M1 containing access time T1. There may exist various reasons for sending an IMSI attach reject message from the network to the communication device 3. As an example, the IMSI attach request may have been received by the SGSN/MME outside the access time group interval. As another example, the time budget or request amount budget may have been depleted. Still another example includes the case wherein the IMSI attach request already contained the data to be sent to the server 2 (not shown in FIG. 5A), as described in further detail in non-prepublished European patent application 08018761, incorporated in the present disclosure by reference in its entirety.

Device 3A may store access time T1, possibly having the form of a time offset in the access time group interval, and, at time T1, transmit the IMSI attach request.

In FIG. 5B, the IMSI attach request is accepted and the IMSI attach accept message contains access time T1 for further application by communication terminal 3A. Data can be transmitted to the server 2 during the established connection. When device 3A has depleted its time budget, the connection may be released (and possibly the device 3A may also be detached from the network).

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory, flash memory) on which alterable information is stored.

1. A method for receiving at least a first access request from a first device and a second access request from a second device at a telecommunications network, the method comprising:
transmitting, from the telecommunications network, a first message comprising a first access time or first access time window to the first device and a second message comprising a second access time or second access time window to the second device, wherein the first access time or the first access time window is different from the second access time or the second access time window; and
receiving, at the telecommunications network, the first access request from the first device at or after the first access time or within the first access time window and the second access request at or after the second access time or within the second access time window.

2. The method according to claim 1, wherein the first access time or the first access time window and the second access time or the second access time window are defined within an access time group interval, and wherein the access time group interval is defined between an interval start time and an interval stop time.

3. The method according to claim 2, wherein the first access time or the first access time window and the second access time or the second access time window are defined as time offsets from the interval start time or the interval stop time.

4. The method according to claim 1, wherein the first access time or a start time of the first access time window and the second access time or a start time of the second access time window are generated by the telecommunications network as random values.

5. The method according to claim 1, further comprising:
monitoring, at the telecommunications network, the receiving of access requests from at least the first device and the second device;
analysing analyzing a time pattern in the monitored received access requests from at least the first device and the second device; and when a change in the time pattern is desired,
transmitting the first message to the first device and the second message to the second device, wherein the first access time or the first access time window and the second access time or the second access time window are such that the desired change in the time pattern is obtained.

6. The method according to claim 1, further comprising:
denying the first access request when the first access request is received prior to the first access time or outside the first access time window; and
denying the second access request when the second access request is received prior to the second access time or outside the second access time window.

7. The method according to claim 6, further comprising delaying the first access time or the first access time window and delaying the second access time or the second access time window.

8. The method according to claim 1, further comprising:
maintaining, at the telecommunications network, at least one of a time budget and a request amount budget for the first device; and
when the first device has not accessed the telecommunications network, denying the first access request when the time budget or the request amount budget has been depleted; or
when the first device has accessed the telecommunications network, initiating a network detach or network release for the first device when the time budget has been depleted.

9. A computer program or set of computer programs comprising software code portions configured, when executed by a processor in a telecommunications network, to cause the processor to perform functions comprising:
transmitting a first message comprising a first access time or first access time window to a first device and a second message comprising a second access time or second access time window to a second device, wherein the first access time or the first access time window is different from the second access time or the second access time window; and
receiving the first access request from the first device at or after the first access time or within the first access time window and the second access request at or after the second access time or within the second access time window.

10. The computer program or set of computer programs according to claim 9, wherein the software code portions are further configured, when executed by the processor in the telecommunications network, to cause the processor to perform functions comprising:
monitoring the receiving of access requests from at least the first device and the second device;
analyzing a time pattern in the monitored received access requests from at least the first device and the second device; and when a change in the time pattern is desired,
transmitting the first message to the first device and the second message to the second device, wherein the first access time or the first access time window and the second access time or the second access time window are such that the desired change in the time pattern is obtained.

11. A telecommunications network configured for receiving at least a first access request from a first device and a second access request from a second device, wherein the telecommunications network comprises one or more network nodes configured for:
generating and transmitting a first message comprising a first access time or a first access time window to the first device and a second message comprising a second access time or a second access time window to the second device, wherein the first access time or the first access time window is different from the second access time or the second access time window; and
receiving the first access request from the first device at or after the first access time or within the first access time window and the second access request at or after the second access time or within the second access time window.

12. The telecommunications network according to claim 11, wherein the telecommunications network is further configured for:
monitoring the receiving of access requests from at least the first device and the second device;
analyzing a time pattern in the monitored received access requests from at least the first device and the second device; and when a change in the time pattern is desired,
transmitting the first message to the first device and the second message to the second device, wherein the first access time or the first access time window and the second access time or the second access time window are such that the desired change in the time pattern is obtained.

13. A network node for a telecommunications network, the network node comprising:
a generator configured for generating a first message comprising a first access time or a first access time window and a second message comprising a second access time or a second access time window, wherein the first access time or first access time window is different from the second access time or second access time window;
a transmitter configured for transmitting the first message and the second message; and
a receiver configured for receiving the first access request from the first device at or after the first access time or within the first access time window and for receiving the second access request at or after the second access time or within the second access time window.

14. The network node according to claim 13, wherein the network node is configured for operating in the telecommunications network.

15. A device configured for transmitting access requests to a telecommunications network for data delivery, the device comprising:
a receiver configured for receiving a message from the telecommunications network, wherein the message comprises an access time or an access time window;
a controller configured for processing the received message and providing a control signal for transmitting an access request to the telecommunications network at the access time or within the access time window; and
a transmitter configured for transmitting the access request at or after the access time or within the access time window.

16. The device according to claim 15, further comprising a storage for storing a further access time or a further access time window derived from the received access time or access time window from the message, wherein the controller is further configured for transmitting a subsequent access request at or after the further access time or within the further access time interval as defined in the storage.

17. The telecommunications network according to claim 11, wherein the telecommunications network is further configured for:
denying the first access request when the first access request is received prior to the first access time or outside the first access time window; and
denying the second access request when the second access request is received prior to the second access time or outside the second access time window.

18. The telecommunications network according to claim 11, wherein the telecommunications network is further configured for:
maintaining at least one of a time budget and a request amount budget for the first device; and
when the first device has not accessed the telecommunications network, denying the first access request when the time budget or the request amount budget has been depleted; or
when the first device has accessed the telecommunications network, initiating a network detach or network release for the first device when the time budget has been depleted.

19. The computer program or set of computer programs according to claim 9, wherein the software code portions are further configured, when executed by the processor in the telecommunications network, to cause the processor to perform functions comprising:
denying the first access request when the first access request is received prior to the first access time or outside the first access time window; and
denying the second access request when the second access request is received prior to the second access time or outside the second access time window.

20. The computer program or set of computer programs according to claim 9, wherein the software code portions are further configured, when executed by the processor in the telecommunications network, to cause the processor to perform functions comprising:
maintaining at least one of a time budget and a request amount budget for the first device; and
when the first device has not accessed the telecommunications network, denying the first access request when the time budget or the request amount budget has been depleted; or
when the first device has accessed the telecommunications network, initiating a network detach or network release for the first device when the time budget has been depleted.
